(19) United States
(12) Patent Application Publication
(10) Pub. No.: US 2016/0050465 A1
(43) Pub. Date: Feb. 18, 2016

(54) DYNAMICALLY TARGETED AD AUGMENTATION IN VIDEO

(71) Applicant: Groopic, Inc., Atherton, CA (US)

(72) Inventors: Aamer ZAHEER, Lahore (PK); Ali REHAN, Lahore Cantt (PK); Murtaza TAJ, Karachi (PK); Abdul REHMAN, Lahore Cantt (PK); Faraz HASSAN, Lahore (PK)

(21) Appl. No.: 14/829,551

(22) Filed: Aug. 18, 2015

Related U.S. Application Data
(60) Provisional application No. 62/038,525, filed on Aug. 18, 2014.

(51) Int. Cl. H04N 21/81; H04N 21/258; H04N 21/4722; H04N 21/234

(52) U.S. Cl. CPC H04N 21/812; H04N 21/23418; H04N 21/25891; H04N 21/4722

(57) ABSTRACT

Systems and methods are disclosed for dynamic augmentation of images and videos. User input and image processing is used to both manually and automatically identify spots in images and videos where content can be convincingly inserted to form native advertisements. Ad servers can identify targeted ads for a particular viewer and automatically supply those ads for insertion in the identified spots when the viewer views the content, thus providing a low-impact targeted advertising experience. For new episodes of an existing show or series, identified spots in the known episodes can be used to identify spots in new episodes, even automatically.

### CROSS REFERENCE TO RELATED APPLICATIONS

This application claims priority to U.S. Provisional Patent Application No. 62/038,525, filed Aug. 18, 2014, which is incorporated by reference in its entirety as though fully disclosed herein.

### TECHNICAL FIELD

The invention relates generally to the field of image augmentation. More specifically, the present invention relates to automated augmentation of images or videos with added static or dynamic content.

### BACKGROUND

Marketing in digital video is an important and profitable industry, as billions of videos are watched every day across the globe. A variety of standard advertising techniques exist, but they each fall short of an advertising ideal in at least one important dimension. Ideally, ads should be dynamically targeted, actionable, and non-interruptive.

The current mainstream video ad formats, in which video ads roll before, during, or after a content video, are interruptive to viewers. These formats are adapted from television (TV) ads which the viewer is forced to watch. In contrast, video ads on the web are mostly skipped by viewers, and this slows down the growth of the video advertising industry.

The predominant monetization model used by the publishers on the broadcast media and internet is through advertisements. On the internet the space on a website is rented as real estate for placing advertisements. Unlike other multi-media content, hosting and publishing video on the internet has proved to be much more expensive due to storage and bandwidth requirements. Video monetization approaches common in broadcast media such as TV, and advertisement media on the internet such as banners have so far been adopted for video monetization. Current video monetization strategies can be categorized as pre-roll, mid-roll and post-roll; also referred to as linear advertisement. There can also be ads that appear on screen with the program content by utilizing only a portion of the screen such as banners and side bars, also referred to as nonlinear ads.

In the case of pre-roll, a small video advertisement (often at or under 30 seconds) is played before the start of the video. Similarly, mid-roll is a small video advertisement which interrupts the video to play. Post-roll is similar to pre-roll except post-roll is placed after the video, and is often used to direct the user to additional content. Banners are overlays on top of the video content being played.

These advertisements may only be profitable for a publisher when they appear for a certain amount of time or when an overlay banner remains on the screen for a certain amount of time. Pre-rolls are usually skipped, as the viewer does not want to wait for the actual requested content. Sometimes skipping is not allowed, however this is considered a bad user experience. Overlay banner ads usually appear at a fixed location (bottom of the screen) and suffer from banner blindness as viewers are trained consciously or subconsciously to ignore predefined standard ad locations.

To overcome these limitations, there have been efforts to make ads part of the video content instead of a banner overlay. Ads can be made part of the video content through product placement, i.e. by placing the product or product ad in the scene at the time of recording the video (referred to as “product placement in content”). Examples of product placement include use of a particular brand in movies, e.g. the use of Pepsi bottles or Starbucks coffee in filmed scenes. Products can also be placed in pre-recorded video through computational means such as by manually post-processing the video (referred to as “computational product placement”). Such ads are referred to as native in-video ads. Post-processing videos to manually introduce advertisements in the recorded videos before they are uploaded on the internet or shown on broadcast channels results in an advertisement that is less distracting for the viewer. And since the advertisement is an integral part of the video, it cannot be skipped or cancelled by the viewer and impression is guaranteed. However, these ads are non-actionable, and targeting based on user persona is not possible with this method.

Another available technology lets publishers and advertisers tag individual products within videos, and making them actionable such that products can be bought from the videos. However, here, the focus is on tagging already present products within videos instead of augmenting the videos to provide new products. Again, this does not allow targeted placement as the same products will appear no matter who sees the video.

The native in-video advertisement mechanisms currently available fail to fulfill core requirements of the ad sector. The ads are static, lack targeting based on a specific audience, and do not allow user interaction with such ads. These ads are shown without disclosing them as being advertisements and people are forced to watch as they cannot be removed once added. Thus they are only suitable for big brands that want to send subliminal messages reminding the viewer of their existence. They also lack any way to measure conversion by the user, since the ads are entirely non-interactive.

### BRIEF DESCRIPTION OF THE DRAWINGS

FIG. 1A is a block diagram of a dynamically targeted ad augmentation system according to an embodiment.

FIG. 1B is a flow diagram of a dynamically targeted ad augmentation process according to an embodiment.

FIG. 2 is a flow diagram illustrating an ad space network flow.

FIG. 3 is a flow diagram of a dynamically targeted ad delivery network process according to an embodiment.

FIG. 4 is a flow diagram of a dynamically targeted ad delivery system process according to an embodiment.

FIGS. 5A-D illustrate snapshots of an ad placement interface according to an embodiment.

FIG. 6 is a sample snapshot of an ad placement interface with a region identified for ad placement according to an embodiment.

FIG. 7 is a flow diagram of a shot detection process according to an embodiment.

FIG. 8 is a flow diagram of a tracking algorithm process according to an embodiment.

FIG. 9 is a flow diagram of an overall process of publishing a video with native in-video ads using the proposed system according to an embodiment.

FIG. 10 is a flow diagram of an overall process of processing a video for augmentation according to an embodiment.

FIG. 11 is an illustration of an interface for scene detection according to an embodiment.

FIG. 12 is a chart demonstrating median track length frame-by-frame according to an embodiment.

FIG. 13 is a flow diagram for motion classification according to an embodiment.

FIG. 14 is a flow diagram for scene clustering based on representative frame extraction according to an embodiment.

FIGS. 15A-C illustrate screenshots of an interface for identifying scenes from representative frames according to an embodiment.

FIG. 16 is a flow diagram for object classification according to an embodiment.

FIG. 17 is a flow diagram for identifying regions of interest according to an embodiment.

### DETAILED DESCRIPTION

Embodiments disclosed herein include a system and method for automatically placing native in-video content which could be any rich media content such as advertisements. The system and methods enable automatic, dynamically targeted, interactive native content (including but not limited to images, videos, text, animations, or computer generated graphics) augmentation in real-time, and decouple meta-data generation and content augmentation. In some cases the augmented content could be an advertisement; in some other cases it could be any additional content. Although the method is general and can be applied to automatic augmentation of dynamically targeted, interactive native rich media content to any image or video, for clarity this disclosure will focus mainly on augmentation of ads in images and videos. Aspects of embodiments of the inventions also include automatic augmentation of a dynamically targeted, interactive native ad to an advert itself such that certain content of an advert gets dynamically targeted while the remaining content of the ad could be fixed.

Aspects of embodiments of the inventions include a method for automatic meta-data generation. This method can be implemented by a computing device executing instruction for various modules including: a shot-detection module; a tracking module that can automatically track features in videos which are then used to improve 3D planes identification; a module for automatic 3D plane identification in videos; a module for spot detection; a module for spot tracking; and a module for manual correction of identified or marked spots through interactive ad placement interface. The method is capable of identifying repetitive shots and/or shots with similarities and enhances the overall process of content (such as ad) augmentation including tracking, 3D planes identification, spot detection and spot tracking. The disclosed system and method provides a real-time augmentation of native, in video, dynamic, interactive content (such as ads) on the videos as well as on an image or sequence of images.

The system and method will be referred to as “ingrain.” The advertisements are not part of video content in the sense that they are not in the originally filmed scene nor do they replace the pixels in the actual video. The disclosed method of placing native in-video ads is automatic, dynamically targeted, and actionable. The ads are less distracting and less interruptive of the viewing experience than ads placed by existing methods, in part because the ads appear to be part of the scene. The disclosed methods inherit all the advantages of previous ad formats and overcome all of their stated limitations. The ad formats enabled by the embodiments described herein can adapt old ad formats (e.g. display, text, or rich media), as well as use emerging native ad formats. The ingrain system can also introduce new ad formats and cooperate with other ad formats.

Embodiments automatically analyze a video and identify regions where an ad can be placed in a most appropriate manner. The resultant metadata is stored on an ad server of the disclosed system. When a viewer requests a video, the video host provides the video data and the system server provides the metadata associated with the video and also serves ads through the system ad server. The ad server interacts with the advertisers to get the ads that need to be placed. Based on the user persona, video content-related tags, and disclosed computer vision-based analysis of the video content, a dynamic targeted and actionable ad is embedded in the video in the form of a native in-video ad. The dynamically targeted ads are served using existing ad services.

A product embodying the invention includes automatically marking regions within a video where dynamically targeted, native in-video ads can be placed. Video content creators are able to guide the process of ad placement if desired. A product embodying the invention also includes manually marking or correcting automatically marked regions within a video where pre-selected ads can be previewed. Multiple such videos are hosted on a website and viewers are brought in through social media and advertisements to view the videos. Existing methods of video ads, as well as native in-video ad methodology, can then be applied to these videos while delivering these ads to viewers. Because native in-video ads are subtle, they can be assumed to be a part of the video content itself.

Aspects of the present invention allow for analysis of “Cooperative Conversion Rate” (CCR) by coupling native in-video ads with conventional video ad formats when the same item is advertised in both formats. In some other cases the present invention also provides for the addition of a post-roll which replays the content of single video to remind the user of the native in-video ad, and then magnifies the ad, leading to a full post-roll. In some other embodiments of the present invention other conventional formats can be coupled with native in-video ads in a similar way.

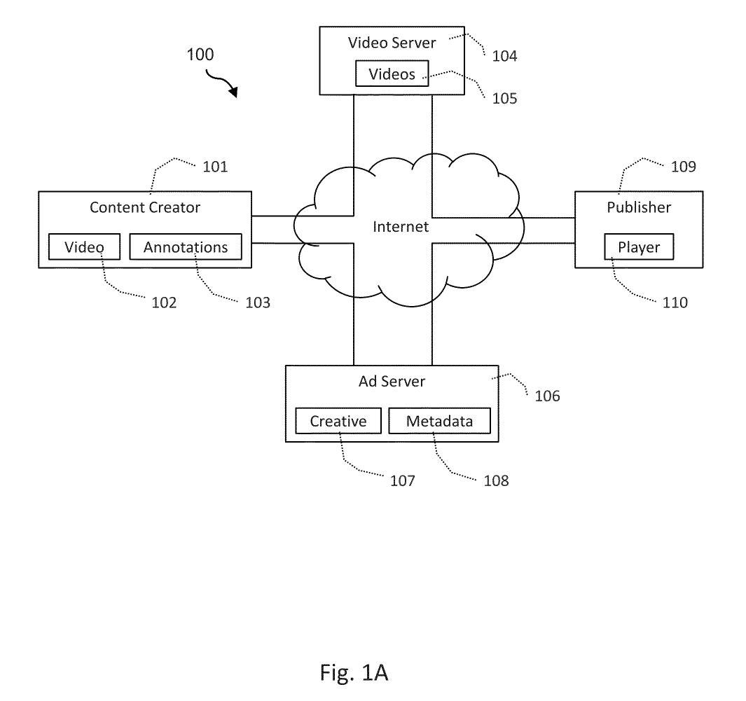

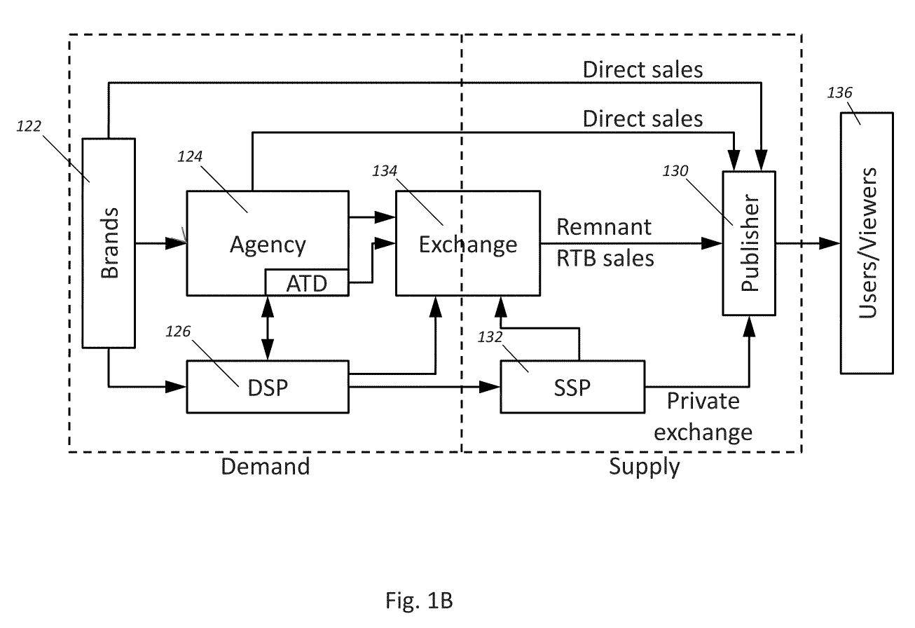

The network flow diagram of the system is shown in FIG. 1A. The content creator 101 creates the video 102 and uploads it on a video server 104. When the content creator 101 uploads the video 102 through our video server 104 or submit the link of already uploaded video 102 to our ad placement interface, the video is processed and generated metadata 108 is stored on our Ad Server 106.

FIG. 1A also shows that when the same video 102 is requested by user through a publisher 109 running our player 110 have our SDK embedded on it, the player fetch the video 102 from the video server 104 and its associated metadata 108 along with the creative 107 and sends it to the publisher. The player then augments the creative 107 on the video in the form of a native content. The creative 107 is fetched based on the user persona and the player 110 allows the user to interact with it as well resulting in augmentation of dynamic, actionable, native in-video ads.

The flow diagram of this process of video submission and metadata generation is shown in FIG. 1B. Companies selling brands 122 provide the primary source for advertising demand. The companies may work through an advertising agency 124 (which in turn may use an agency trading desk “ATD” or other digital content management) and/or a demand-side platform “DSP” 126 for managing their ad portfolios and budgets. Publishers 130 provide the primary source for advertising supply, and may manage their available ad space directly or through a supply-side platform “SSP” 132. An ad exchange 134 may further mediate and manage these transactions, all in order to provide ads to the user 136.

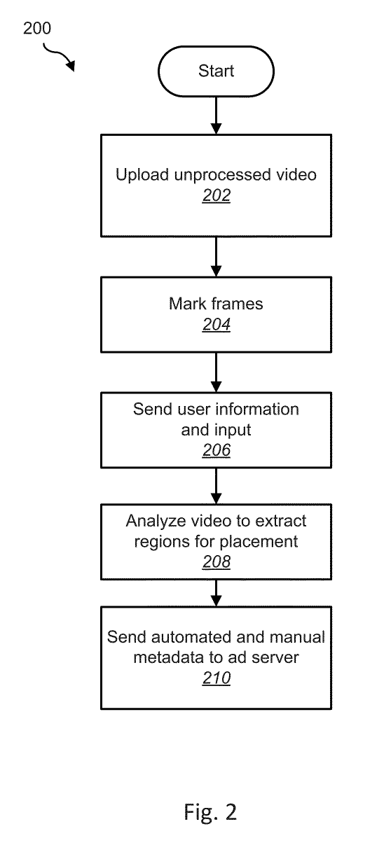

FIG. 2 is a flow chart 200 illustrating some of the steps associated with receiving an unprocessed video and adding metadata to allow for automated product placement by an ad server. An unprocessed video is uploaded (202). This may involve supplying or creating new content or, in some implementations, may involve providing a link to existing content available elsewhere. Optionally, frames may be marked with indicators (204) providing suggestions by the user as to where advertising might go. The video, including any information or input supplied by the user, is submitted for analysis (206). Automated processes analyze the video to identified regions for placement (208). The resulting metadata, which may include a combination of manual and automated signals inviting product placement, are sent to the advertisement server (210).

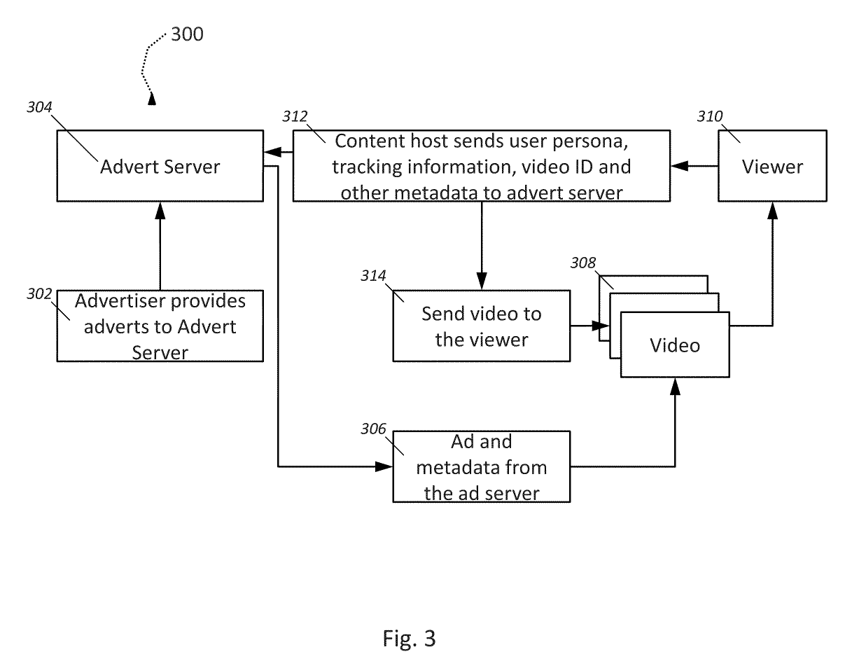

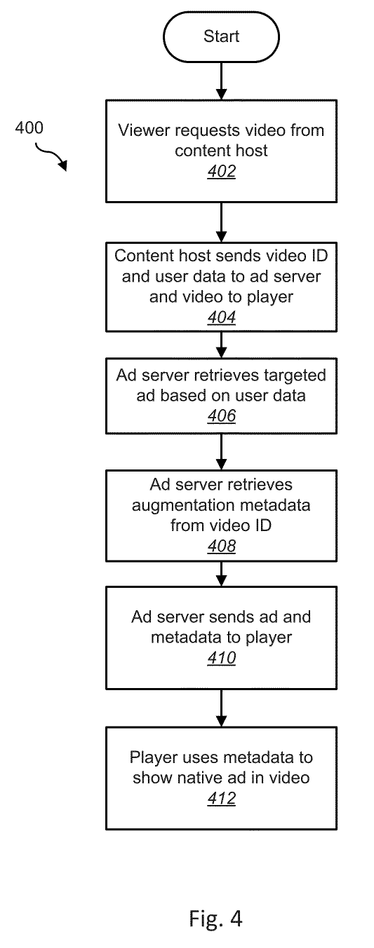

The flow diagrams of this dynamically targeted ad delivery network are shown in FIG. 3 and FIG. 4. FIG. 3 shows an example of a data flow between actors and devices within an ad delivery network 300. An advertiser 302 provides advertisements to an ad server 304 which in turn provides both ads and metadata 306 to videos 308 shown to viewers 310. The content host 312 receives viewer data which it supplies to the ad server 304 and uses in selecting and generating content 314 to include in the videos 308 shown to the viewers 310. Note that both ad and video generation include cycles that accept and respond to feedback from viewer data.

FIG. 4 is a flowchart 400 illustrating a process by which viewer feedback results in dynamically targeted advertising. A viewer requests video from a content host (402). In response, the content hosts sends the video to the video player while sending the video ID and user data to an ad server (404). The video player may be browser-based and may be associated with the user's end device rather than the content host server or ad server, although in some embodiments certain steps may be carried out distant from the video player.

Using targeting algorithms, the ad server retrieves a targeted ad based on the received user data (406). The ad server also receives augmentation metadata which provides instructions for adding the native advertisement to the particular video (408). The ad server sends both the ad and the metadata to the video player (410), which in turn uses the metadata to include the native ad in the video as the video is played for the viewer (412).

The steps of the flowchart 400 show that, in order to make the advert dynamically targeted, user tracking information (such as its persona) is also sent to the ad server to fetch appropriate targeted ad. The same augmentation can be applied with other rich media content such as augmentation on images instead of videos as well as augmentation of any images, videos, animation and graphics on any video. The rich media content is not limited to advert only, instead it could be any generic rich media content.

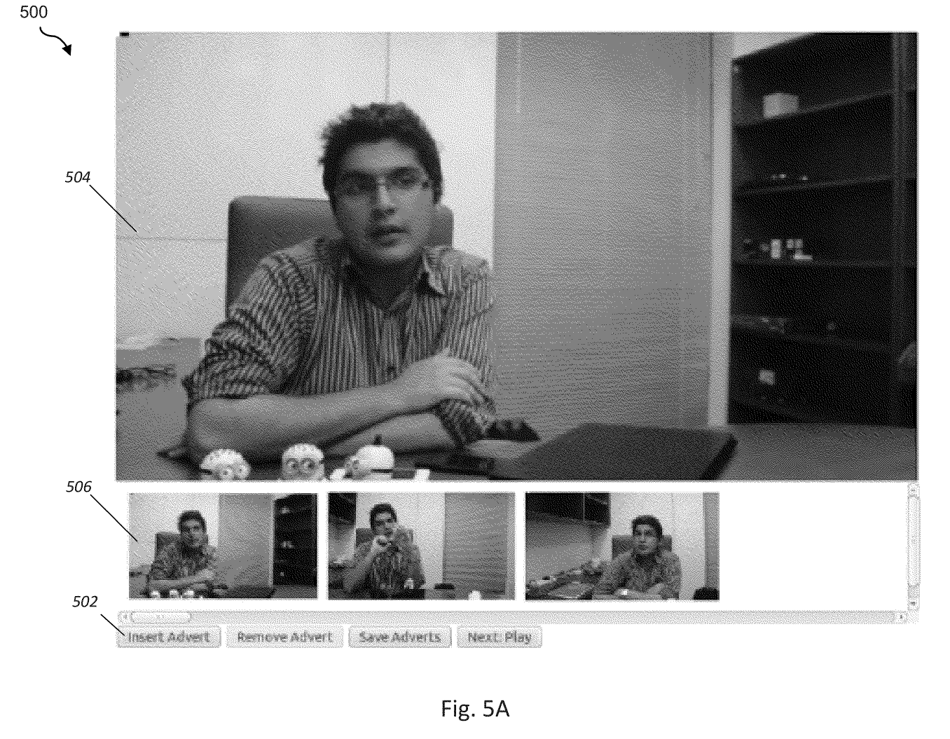

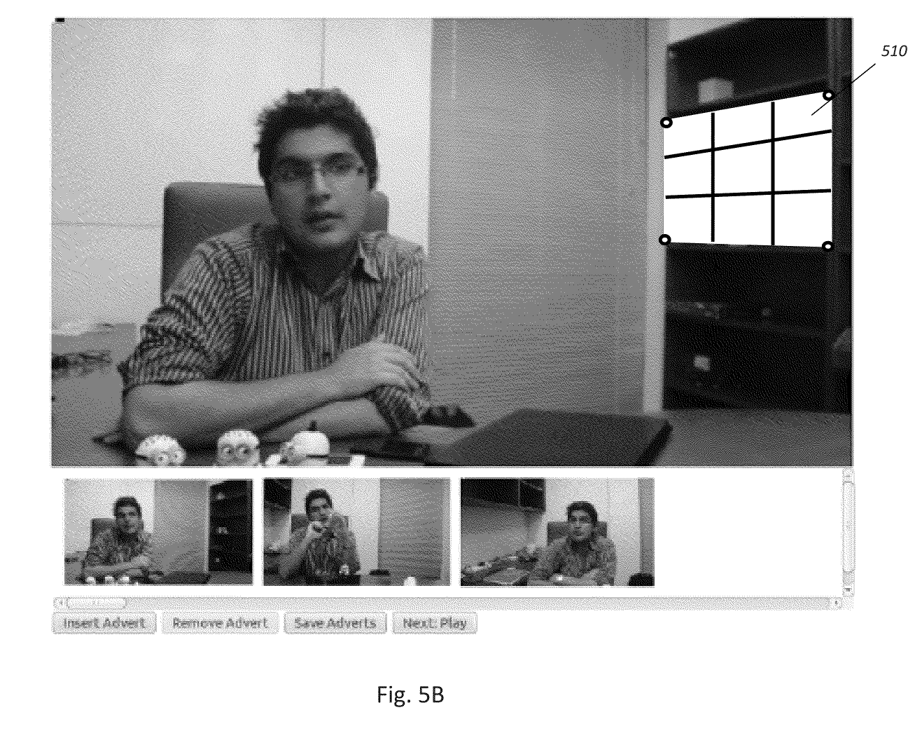

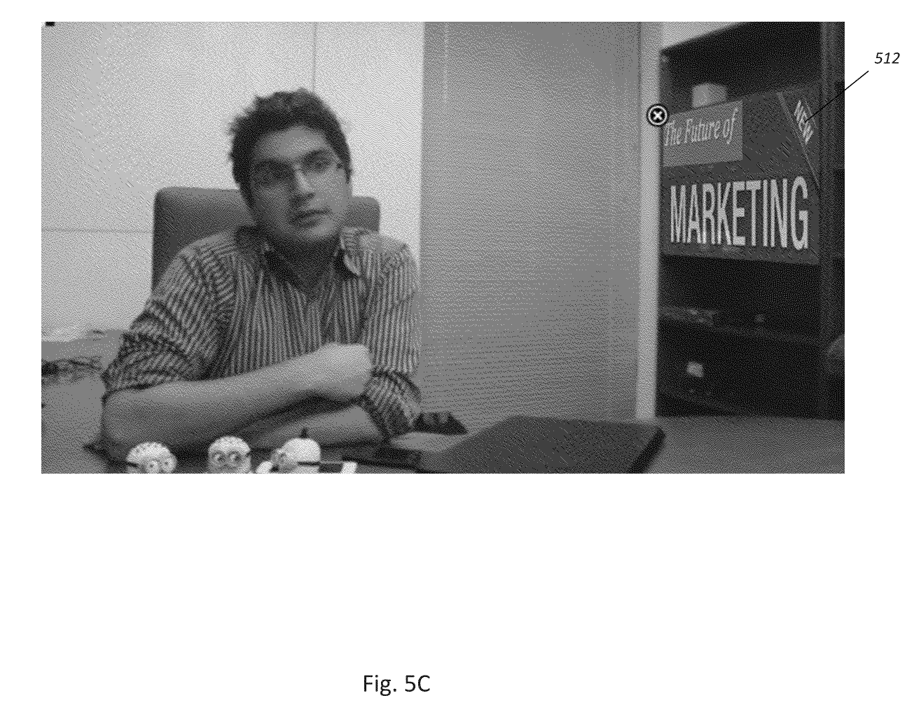

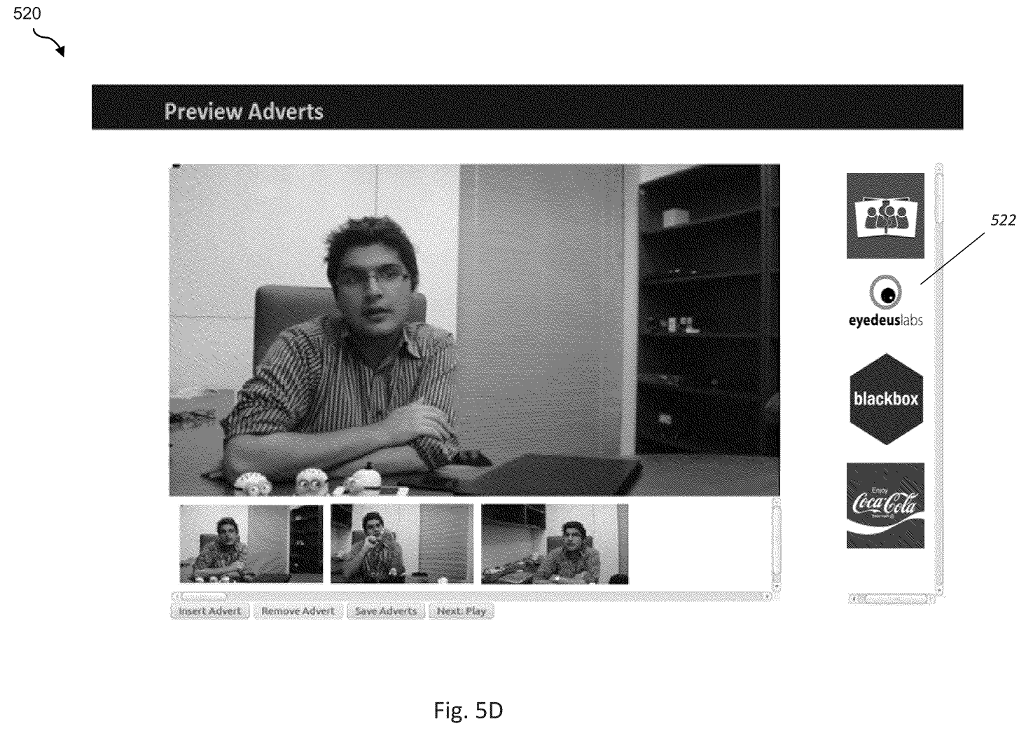

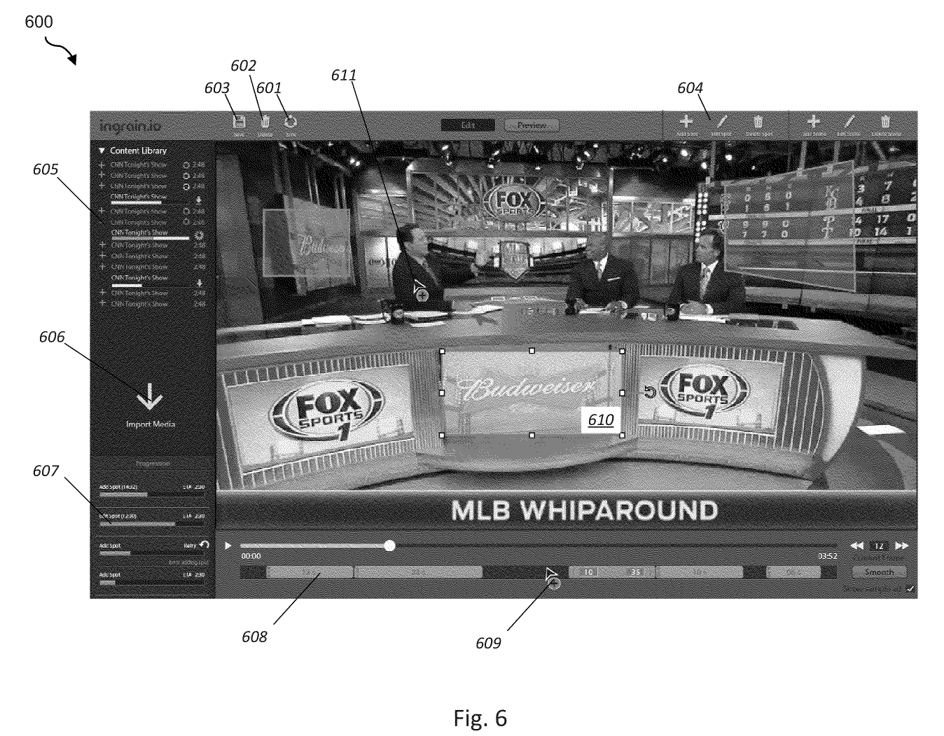

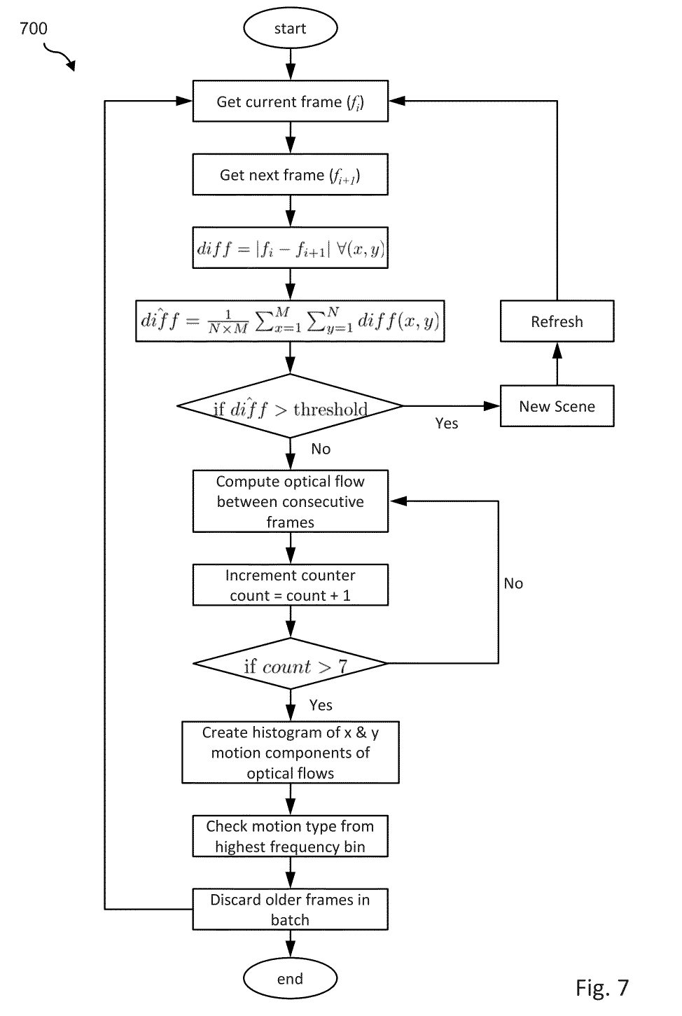

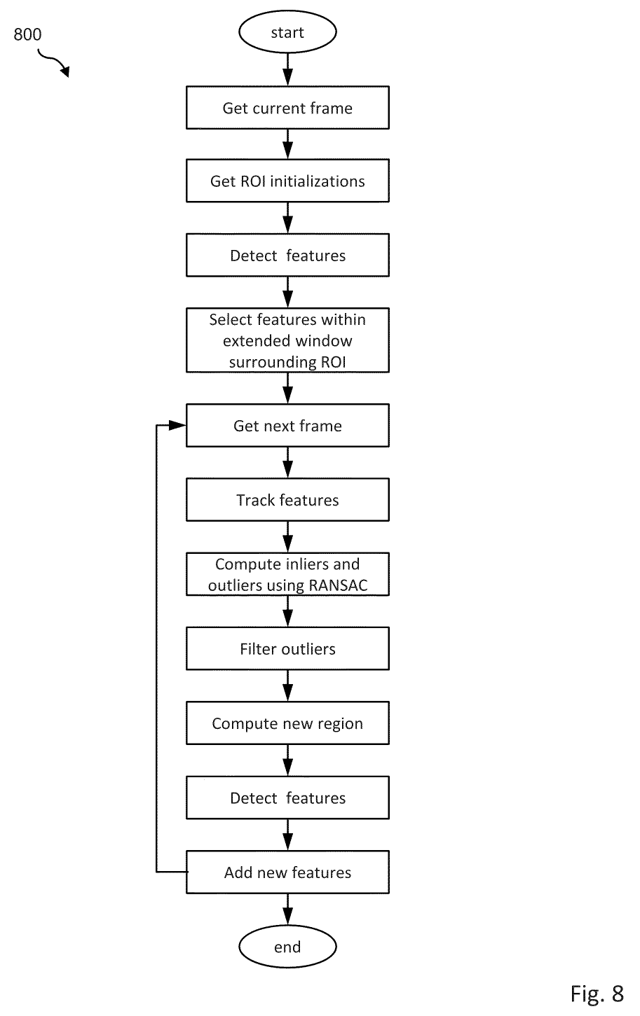

Embodiments of the ingrain system described herein include a user interface referred to as the “Ad Placement Interface” (AdPI) (see FIG. 5, FIG. 6A, FIG. 6B and FIG. 7). The system further includes software embedded in a video player (e.g., mobile phone, smart TV, tablet device, laptop computer, personal computer and any other device capable of playing a video) using the disclosed ingrain software development kit (SDK) to enable users to view and interact with native in-video ads (FIG. 8).

In an embodiment, the process of native in-video advertising starts with a content producer accessing the AdPI. The user can either upload a new video to an ingrain system server or submit a link to a video already uploaded on another video-hosting website. In some cases the video link can be discovered or notified automatically. The ingrain system temporarily downloads the video to a system ad server (AdPI backend server) for processing. The video upload and processing is demonstrated in FIG. 1B and FIG. 3.

FIG. 5A shows an example of ad placement interface 500 in which different scenes or shots can be manually marked for ad placement. The interface 500 includes navigation buttons 502, a primary video window 504 in which a particular scene or shot is displayed, thumbnails 506 that can be selected representing other scenes or shots.

A user can place one or more marks in the video window 504 to represent locations where a native ad could be placed. Such a mark 510 is shown in FIG. 5B, which is otherwise identical to FIG. 5A. As shown in FIG. 5C, the system may automatically replace the identified mark 510 with an advertisement 512. In some implementations, a user may be able to select and preview the addition of different native advertisements to the shot, as illustrated in the interface 520 shown in FIG. 5D. The interface 520 includes a selectable list 522 of brands that can have ads inserted.

The detailed ad placement interface 600 of a disclosed ingrain system is shown in FIG. 6. This interface allows to add videos into the system. It also allows visualizing and editing the meta-data associated with the videos. Multiple videos can be added to or removed from the list 605. A video can be added by simply dropping it on the import media 606 interface. On any selected video several automatically segmented shots/scenes can be visualized and edited using shot/scene edit interface 608, using the shot add pointer 609 or through shot/scene edit toolbar 604. Similarly, on each shot/scene several spots 610 can be added automatically through algorithm or using a spot add pointer 612. As spots are being added, there are processed simultaneously for generation of tracks, projection matrices and other metadata. The progress on each of these spots is shown in spot list 607. The metadata associated with the selected video can be saved, deleted and synced to the ad server using save 603, delete 602 and sync 601 buttons respectively.

During the video registration phase the following six major operations are performed on the video to enable automatic augmentation of native in-video ads:
Shot boundary detection;
Shot classification;
Identification of 3D planes;
Tracking;
Spot detection and spot tracking; and
Review and correction

These operations are performed through the use of novel functionalities available via the ingrain system. First, the video is automatically segmented into multiple shots. The system then automatically identifies and tracks multiple 3D planar regions within each shot. Entire planes or smaller regions within these planes are then selected as spots for ad placement. The system then computes various transformations to be applied to the advertisement in order to embed it into these 3D planes. The resulting information is stored in ingrain system databases as metadata along with a video identifier (ID). When the same (now processed) video is accessed by the viewer through a video player that has the ingrain SDK running on it, the SDK uses the tracking information of the viewer (such as his/her persona, his/her browsing history, etc.), requests a targeted advertisement, accesses the metadata stored with video, transforms the ad into a native ad, augments the advertisement into the video as an overlay, and displays it to the viewer. The system can also perform refinement to fit the ad within the content of the video. These refinements include, but are not limited to: blending the retrieved ad content within the video content; relighting the ad according to the content of the scene to create a better augmentation with fewer visually perceivable artifacts; and selecting an ad content that is similar to the video content. This similarity between ad content and video content includes one or more of the following: color similarity, motion similarity, text similarity, and other contextual similarity. The ad content could be an image, animation, video or simply a piece of text. The result of this process is automatic placement of a native in-video advertisement that is non-interruptive, dynamically targeted, and augmented.

### Shot Detection

The first major operation on the video is that of shot detection, or extraction of shot boundaries. Videos are usually composed of multiple shots, each of which is a series of frames that runs for an uninterrupted period of time. Since the present ad format augments an ad within the 3D structure of the scene, it is valid only for a single shot or a portion of a shot. Once a video is received by the ingrain system ad server, the first main processing step is to identify the shot boundaries. These boundaries are identified by analyzing the change in the consecutive frames. A shot boundary is detected on a sub-sampled version of a video using two different tests: i) trivial boundary test; and ii) non-trivial boundary test. The trivial boundary test is a computationally efficient mechanism to identify a shot boundary. The non-trivial boundary test is performed only when the trivial test fails. In the trivial boundary test, the system acquires a current frame fᵢ and a frame after a certain offset k,fᵢ₊ₖ, and computes an absolute distance (in some cases sum of squared distance, or “SSD,” is computed instead) between the two as follows:

diff=|fᵢ−fᵢ₊ₖ|¤*x,y)

The pixel-wise difference is then added together to obtain a single difference value (Sum of Absolute Difference (SAD)):

$$\hat{diff} = \frac{1}{N \times M} {\sum }_{x = 1}^{M} {\sum }_{y = 1}^{N} diff ( x , y )$$

If the SAD value (or SSD value in some cases) is greater than a certain automatically computed threshold (defined as μ+ασ, where μ and σ are mean and standard deviation whereas a is a predetermined blending factor which may be set, for example, to 0.7), it is declared as a shot boundary, and the next frame fᵢ₊ₖ is considered as the starting of a new shot or scene. In cases when the SAD value (or SSD value in some cases) is below the computed threshold, it is considered as a non-trivial case and frames are processed further for detailed analysis. This case ensures that there are no false negatives, i.e. missed scene changes. The non-trivial boundary test tries to find the precise boundary of every detected shot. It achieves that by processing the differences between each shot, including, for example, the motion and edge information

In non-trivial analysis, motion information between the frames is computed. In some cases motion information is only computed between consecutive frames and in some other cases motion information is computed between frames separated by a fixed number of frames or intervals. In one approach, the optical flow between consecutive frames is computed and stored for later motion analysis. Instead of computing optical flow between just the current and next frames, the flow is computed between each consecutive frame up to n frames following the current frame. In some cases the optical flow is computed between consecutive frames up to n frames before the current frame provided that at least n frames have already been processed. Each time an optical flow is computed, a counter is incremented and it is checked to determine whether the counter has reached its maximum desired value (initially set in the system). For example, a maximum value of 7 is used in some cases, and in other cases the maximum value is computed based on the frame rate. In yet other cases, instead of motion information, some other motion feature is computed.

### Shot Classification

Once the shot boundaries are identified, the ingrain system then performs classification of shots. To perform the shot classification, the system computes the statistics on the computed motion information. In the case of optical flow, a histogram of its X and Y motion components is created. In some cases this histogram is computed by grouping together similar motion values (i.e. values within the interval of [x−a, x+a], where a is a positive real valued number) into the same bins of the histogram. This grouping may be done independently on X and Y components, or may be done on a total magnitude of the vector obtained from X and Y components. Frequencies of various bins of the histogram are then analyzed to estimate the motion type in the shot. In some cases only the frequency in the highest bin is analyzed; if its value is below a certain minimum threshold, its motion type is declared to be static (i.e. without significant motion). If its value is above a higher maximum threshold, then its motion type is declared to be camera motion. Otherwise, with values between the two thresholds, the motion type is declared to be an object motion—that is, one or more objects in the scene are moving. As an alternative, the motion type may be classified as static when the frequency of the highest bin is lower than a threshold and as continuous motion when the frequency of the highest bin is higher than a threshold. These low and high thresholds can also be dynamically computed. The continuous motion case can be further classified as either being one that can be defined by a single homography or one that can be defined only by multiple homographies.

The shot detection and classification information is stored in the metadata along with the video to be used by later modules, such as a tracking module to decide where to stop tracking previous frames and perform reinitializing of tracks. The system then proceeds to process the next shot. The flow diagram 700 of an algorithm for shot classification is shown in FIG. 7.

### Identification of 3D Planes

The next operation is to automatically identify 3D planes across some or all of the scenes in the video. The planes are identified by analyzing the geometric information in the scene. The ingrain system identifies regions in the scene that are suitable to place ads without degrading video content. These include regular flat regions in the scene such as flat walls, windows, and other rectangular structures common in the man-made world. To identify such 3D planes in the scene, an embodiment uses angle regularity as a geometric constraint for reconstruction of 3D structure from a single image (referred to as “structure from angle regularities or “SfAR”). A key idea in exploiting angle regularity is that the image of a 3D plane can be rectified to a fronto-parallel view by searching for the homography that maximizes the number of orthogonal angles between projected line-pairs. This homography yields the normal vector of the 3D plane. The present approach is fully automatic and is applicable for both single plane as well as multi-planar scenarios. The invented method does not place any restriction on plane orientations. Many flat region hypotheses are generated using angle regularity, vanishing points, and single view learning based methods. The rectangular patches used for segmentation need not be axes-aligned. The camera can be in any arbitrary orientation, and visibility of the ground plane is not required. The planar identification process gives multiple hypotheses for spot identification.

### Tracking

Once the hypothetical flat 3D regions are identified, the next major operation is to track and verify these regions across the shot. As discussed earlier, shots are classified into either static or continuous camera motion whereas camera motion can be further classified as either camera motion that can be explained by single homography (PTZ or single plane, i.e. no parallax) or camera motion that can be defined only by multiple homographies (multiple planes as well as translation, i.e. parallax). Depending upon the camera motion, two different tracking algorithms are disclosed here. In case of generic camera motion, multiple planes within the same frame are identified and tracked; in the case of of PTZ or single plane, only one homography is needed. When a user submits a video or a video link through the AdPI, the tracking process can start in one of the two ways: i) automatically through 3D understanding of the scene; or ii) after manual initialization by the content producer or the AdPI administrator.

In one embodiment, the multi-view tracking algorithm is an extension of single video geometric video parsing and requires computing lines and vanishing point matching along with feature point tracking. These matched vanishing points serve to constrain the search for homography (by providing two fixed correspondences in RANSAC sampling) as the whole image could be related by a single unconstrained homography in a narrow baseline case. Thus the homography will always correspond to the correct vanishing points and the tracked rectangle will always be distorted correctly. All parallel lines grouped with one vanishing point do not correspond to the same plane. In fact coplanar subsets are identified by further analyzing the matched lines. This way, when the user marks a rectangle by snapping it to some lines in the neighborhood, all the needed homographies are computed without performing any feature tracking. Moreover, the orientation map of planes generated from physically coplanar subsets is more accurate as well. This also allows the user to visualize other physically coplanar lines when the user marks the rectangle as an additional visual aid, either confirming the rectangle tracking or asking for additional checking in a subsequent frame (e.g., in case the physically coplanar set is not detected correctly).

Optionally, Delaunay triangulation can be utilized so that even a rectangle marked inside completely flat regions will be associated to some features (which form the Delaunay triangles it intersects with). If two vanishing points are available, they can be utilized as a default part of the RANSAC random samples and two other points can be picked at random. This ensures additional speed and stability. The population for RANSAC is all the feature points inside a marked rectangle as well as (optionally) the features forming all the Delaunay triangles it intersects with.

The initial results of these tracking processes can then be refined using projective flow based techniques. For a moving camera scenario, this step also involves background subtraction to test for the visibility of the rectangle in all views.

In a different embodiment, a single-view tracking algorithm may be required where no or little camera motion is identified within a shot or scene. The single-view tracking algorithm uses adjacent line-pairs and appearance-based segmentation. Physically adjacent line-pairs are detected (similar to SfAR), with an additional appearance based test like a Harris corner-ness measure, edge-corner measure etc. to remove the false positives in SfAR line-pairs. Since these are only adjacent pairs in 2D they might occur at discontinuous lines in 3D. If the discontinuous line is on the rectangle boundary, the line evidence is assumed to be coming from two lines in 3D, one on each plane. When geometry doesn't provide enough cues, the system may fall back to segmentation for rectangles as well as planes using an approach based on appearance, texture, and gradient entropy.

### Spot Detection and Tracking

The next major operation is to identify and track spots for ad placements. Ads are not supposed to be placed on the entire detected and tracked plane; instead a small sub region within these planes called a “spot” is used to place ads. These spots are detected using a ratio test performed on a set of rectangles that were used to form a plane in 3D. The detected spot tracking is performed by utilizing the tracks obtained for each plane. In fact, tracks associated with a spot are simply a subset of tracks associated with the plane inscribing that spot. Additional smoothing, filtering and refinements are applied to remove jitter or noise in these tracks. Tracks along with 3D position and orientation of planes and spots across the shots are then stored in the meta-data along with the video.

The ingrain method and system can also perform analysis of the video content and can deliver ads that are relevant to the video content. Various aspects of the video can be analyzed by the system, including but not limited to 3D content of the scene in the video, color content, scene lighting, position of light sources (particularly sun vector), motion information, amount of excitement in the scene using audio visual analysis, understanding through subtitles and available transcription via speech-to-text etc. The ad can be modified to better fit the content of the video in one or more of aspects of the video content. These modifications include, but are not limited to, color blending, text, conversions to appropriate size, shape, language etc.

In the case of manual initialization, the user is asked to mark a region (spot) in the shot appropriate to place an advertisement. AdPI also allows users to manually select one of the suggested ad spot or, identify a region or a spot in one of the frames of a shot as a potential place for one or more native in-video ads. Region marking involves drawing a polygon which could be a 4 vertex polygon representing a projected rectangular patch in the scene. The user is only required to mark the rectangle in just one frame of the scene. The system then automatically tracks this polygonal patch across each frame of the scene. Tracks of both manually marked spots as well as automatically detected spots can be interactively corrected through the AdPI. In some cases, the ingrain system automatically tracks identified 3D planes (identified through automatic plane identification algorithm or through manual identification) using feature-based tracking. The system first detects the salient features in a frame and then tracks them in the next frame. To improve robustness against scene variations, additional features are also detected and added in the list of features to be tracked in the next frame. Feature tracking can also be performed using any tracker that makes use of spatial intensity information to direct the search for the position that yields the best match.

The system then performs a random sampling of the features using a modified RANSAC implementation that identifies inliers and filters outliers. The outliers are then removed from the list of features and a new region is computed using the existing features (i.e. the set of inliers). To speed up the overall tracking, feature correspondence between two consecutive frames is done by searching for each feature within a small rectangular window centered on each feature or an extended window that encloses all the features and also includes an extra margin within the window. This also increases robustness against symmetric structures within the scene.

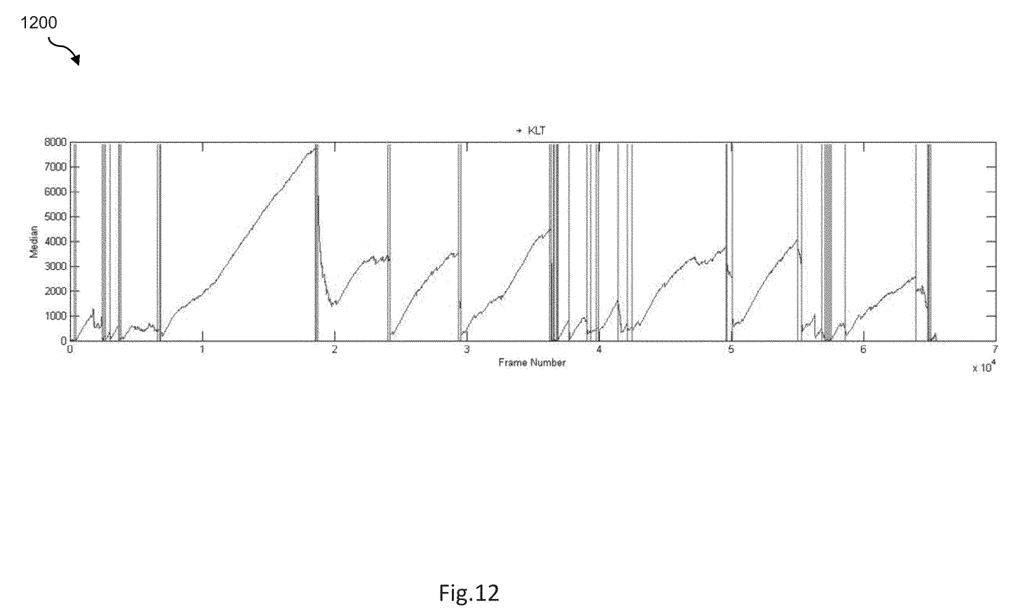

Across two consecutive frames, some portions within the polygon may get occluded or lost due to noise while some others may reappear. To enable consistent and smooth tracking across the shot, at each frame new features are detected and features with significant high confidence are made part of the set of features to be tracked. Similarly, features that are occluded or noisy tracks result in a very low confidence match and are thus discarded. Once the feature correspondence is done, the extents of the polygon are established and any new features that are detected outside these extents are also discarded. A flow diagram of the tracking algorithm according to an embodiment is shown in FIG. 12.

Once all the polygonal regions have been tracked across their respective shots, the system computes the projection matrices between each frame and between all standard ad sizes (including projection of 3D ads) and the deformed ad placement region in the scene. Tracking information along the projection matrices is then stored for each video frame within the database on the system server. In some cases the database can be a relational database, in some other cases that database could also be a flat file based database. The system then analyses the appearance of ad placement regions as well as the remaining frames for selection of advertisements with appropriate color schemes.

### Review and Correction

In some implementations, the final major processing step is that of preview and correction of detected and tracked ad placement spots. Once the video is processed at the ingrain server and all the transformation matrices are computed, the video is presented to the user as a “preview”. The AdPI presents these identified planes to the user as suggested regions for advertisement placement. These planes are presented as editable polygons whose vertices can be adjusted by the user. The user can select one or more of such planes, or can modify these planes to improve the quality of regions for ad placement. Once the user has finished editing the planes, the system tracks them across their respective shot using the same tracking approach as the one employed in case of manual initialization of regions.

In some cases, once the video is uploaded or its link is submitted to the ingrain system, the user can opt to wait for the processing to complete, or the user can be informed via a message that the video is ready for preview. In some cases the preview is available once the entire video is processed. In yet other cases the preview is available once a particular shot has been processed. The system selects an advertisement from the ad repository to be inserted into the scene. The ad could be selected by analyzing the appearance properties of the scene, or picked at random and then modified to resemble the color and lighting properties of the scene. The ad could also be selected by the user of the system from the list of available advertisements. The user of the ad placement and preview (APP) module of the AdPI can change as many ads as desired.

The ingrain interface also allows users to correct any inaccuracies to maximize the viewing quality of the scene. The interface also allows the user to select the color scheme of suitable ads. Each time the user previews the video, the system dynamically modifies the ad for best viewing quality using the tracking information, the computed projection matrices, and the appearance information. These modifications include transforming the advertisement using the projection matrices and warping it into the ad region, alpha blending the advertisement with the scene, edge preserving color blending using Poisson image editing through Laplacian pyramids, and relighting. In some cases the video content and the ad placement polygon are first projected into the advertisement space using the inverse of projection matrices. The advertisement is then modified using the same techniques listed above, and the modified ad is projected back and embedded into the scene using the projection matrices.

In some cases all the processing to augment an advertisement into the video is done at the system server and only the processed frames are transmitted to the user for preview. In some other cases, all or some of the processing is done by the video player on the client terminal using a system software module running on the client terminal. In some cases, tracking, estimation of projection matrices, and automatic video understanding are performed at the system server side while the projection and blending are done by the video player on the client terminal using system methods and the corresponding metadata of the video stored on the ad server. In some cases, the system can analyze the process capabilities on the client terminal and dynamically decide which steps should be processed at server side and which ones at client side to maintain the responsiveness of the system.

Once the content creator is satisfied with the output quality of the video, the modified meta-data is stored back on the system server and the video is published for viewing by the viewers. Note the advertisements used at the time of preview are just for preview purposes and the actual advertisement shown to the viewer is totally dependent on the tracking information about the viewer and other meta-data associated with the video.

### Process

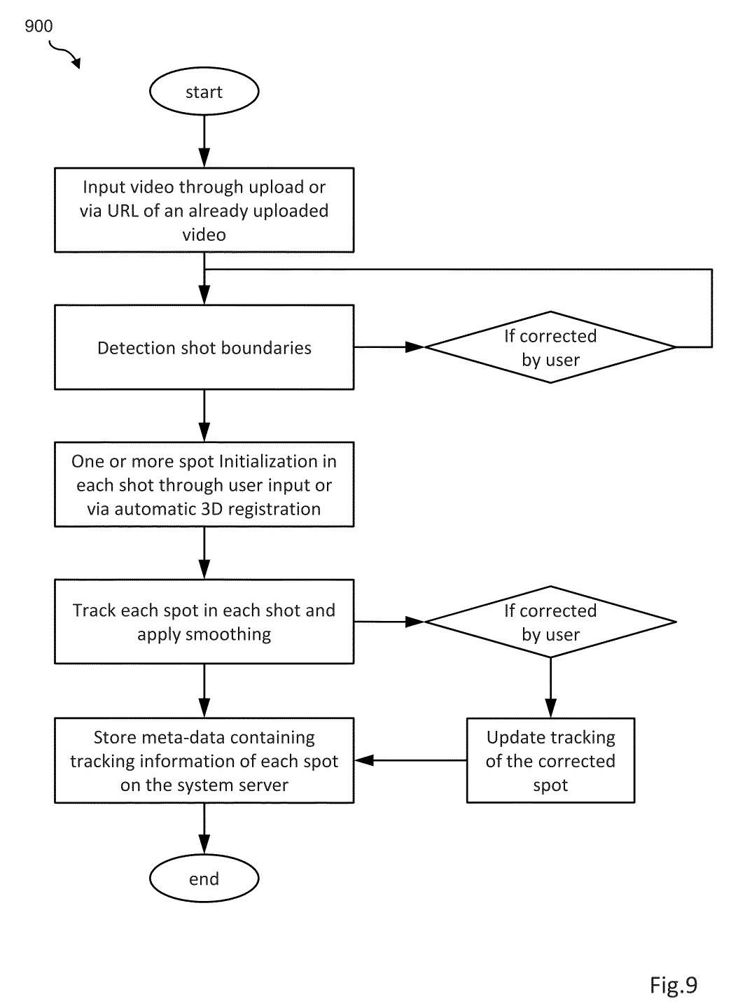

An example of an overall process 900 for publishing a video with native in-video ads using the proposed system is illustrated in FIG. 9. The content generator simply provides a video to the proposed system. This video could be uploaded on any platform or could be uploaded from a content generator's own storage. The video can also originate on another mobile platform is not required to be on stored on the system. The system can acquire the video for processing in any manner.

Once the video is uploaded on one of a system or a partner publisher's server, the system processes the video and automatically identifies the region(s) within the 3D scene of the video where native ads can be placed. The content generator can then preview and make any adjustments if needed. This metadata is then stored along with the identity information on the system. Videos provided via other platforms are then removed and only those video are kept which the content generator uploaded from local storage to the system.

When the viewer plays the video using a video player with the ingrain system software, the SDK takes the user persona information and video metadata and requests a targeted advertisement. Using the metadata, these regions are automatically replaced by dynamically targeted advertisements without disrupting the viewing experience. This augments the video content with the proposed ad content.

These ads are also interactive in the same manner as banner ads, in that the user can click on or otherwise select an advertisement in order to proceed to website associated with the advertised product. The proposed ad format is also dynamically targeted and changes based on the user persona. Furthermore, the proposed ad format is for any screens including Smart TV, touch pads, mobile devices and wearable devices. The described system and methods are also applicable to real-time augmented reality in addition to pictures and videos on desktop and mobile.

Using publication methods according to the present invention, systems could be set up to remunerate content publishers in a variety of ways. For instance, the system can be presented as a platform interposed between the ad delivery networks and the publisher. The system software (also referred to as a “player host”) running on video players (with system SDK) acts as a publisher for any website or mobile application that embeds it. The platform receives compensation for delivering the ad which will then be shared with those who have embedded the player host. The compensation can be calculated using any standard online advertising metric (such as CPM, CPC, CPV, or CPA). The amount of compensation offered to the player host can be negotiated on client-by-client basis. Since the ad content is modified to make it a non-distracting part of the 3D scene present in the video, CPM and CPV methods are redefined for native in-video advertisements. The disclosed new format of ads is less disruptive for viewers compared to existing formats. Thus, there are more impressions, resulting in higher conversion rates. Considering the lack of monetization on video content particularly in mobile space, once it is proven that the proposed native in-video advertisement mechanism is more effective both for advertiser and publisher, it can be widely accepted.

### On-Boarding

Each week, a variety of popular shows release previously-unseen new episodes, which provide additional opportunities for native content. Although the episodes are new, a given show will often re-use the same sets and camera angles in episode after episode. This disclosure introduces a technique for “on-boarding,” by which data from existing episodes of a give show can be used to more accurately and efficiently analyze a new episode of the same show.

The on-boarding process is performed to compute several of the show specific parameters and data that can be used for fully automatic processing of unseen video of the already on-boarded show. On-boarding involves understanding the visual content present in the scene, creating the 3D understanding of the scene, training classifiers for recognizing objects present in the scene and tuning of parameters of several modules. Each of the following modules may be especially tune or trained for on-boarding: shot/scene segmentation, duplicate and target scene identification, 3d plan identification, spot ROI detection, training of object detectors, and mapping of scene lighting and shading.Duplicate and Target Scene Identification

In some implementations, on-boarding is an interactive process involving user input in understanding the video content. In some other embodiments, on-boarding is a fully automated process that can understand and on-board a new unseen episode or show without any user input.

When a new show is required to be on-boarded, multiple episodes are provided to the ingrain system. In some implementation, user feedback is taken into account in order to refine the on-boarding process and avoid major errors.

In one implementation, the system first performs the shot segmentation and presents the output to the user, as described above with respect to scene segmentation and FIG. 7.

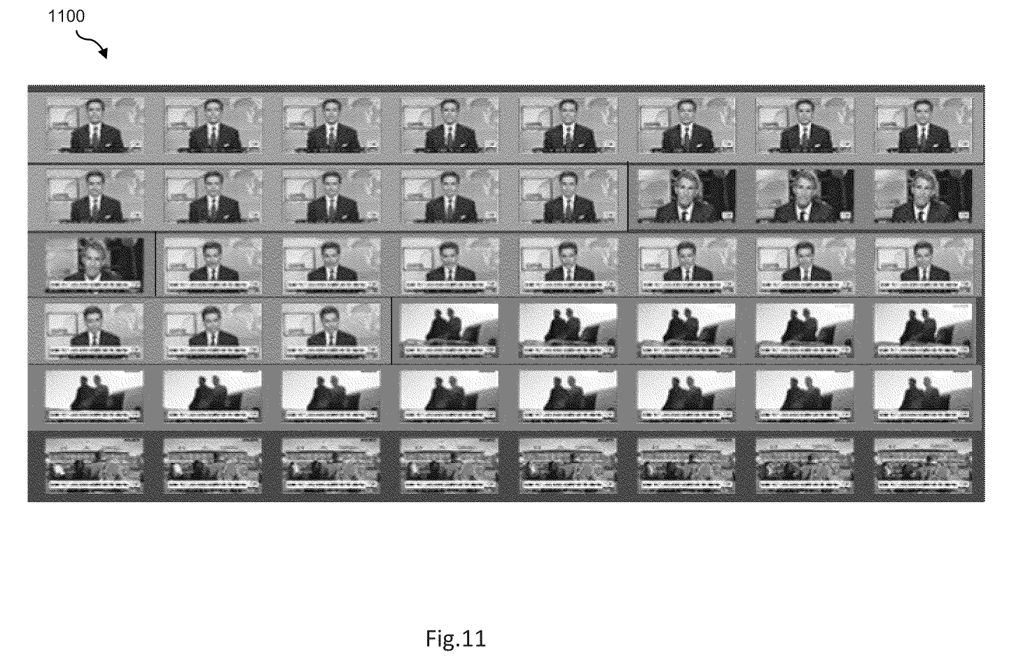

Using the shot segmentation interface 1100 as shown in FIG. 11, the user can correct any of the incorrectly identified boundaries. The interface allows increasing/decreasing scene boundaries, deleting a scene, and adding a scene on frames not being assigned to any scene. The user can also leave any number of frames unassigned. This facilitates the user in removing scenes from the on-boarding template that are being shot at a random or one-time location and do not contribute to identifying regular or repeated scenes. Once the user has completed reviewing and correcting any of the shot segmentation issues, the ingrain system uses the provided input as a basic template for further episodes. The system can then start performing automatic parameter tuning to ensure maximum accuracy.

In some embodiments of the present invention, global feature point tracking is performed across the entire video. Global feature point tracking is performed by first detecting salient features in each frame and then finding correspondence between the features in consecutive frames. In some cases a hybrid of KLT and SIFT is employed to perform tracking. The hybrid approach first identifies KLT on a low resolution video to identify moving patches. More precise tracking is then performed in each of these patches using SIFT. The hybrid approach is effective in providing computation efficiency and lowers time complexity.

In some embodiments of the present invention, the hybrid tracking process can result in multiple one dimensional signals. The system can perform C0 (end point) and C1 (first derivative) continuity tests on each of these signals to compute track continuity score. The aggregate of track continuity score can be computed on each frame of the video. Applying a threshold to the track continuity score can be used to detect a scene boundary. In some cases, during on-boarding, the aggregate of track continuity score can automatically tuned to maximize accuracy.

In some cases, several other features are also computed using the hybrid KLT and SIFT signals to identify scene boundary. These features may include minimum, maximum and median track length, birth and death rate of tracks in an interval, variance and standard deviation, and others. FIG. 12 shows a graph 1200 of median track length, with previously determined scene changes marked with vertical lines; as illustrated, a sharp decline in median track length is a strong indication of scene change. A feature vector is then formed using these scores on which a classifier (such as SVM) is trained to classify an interval of frames as containing shot boundary or shot transition.

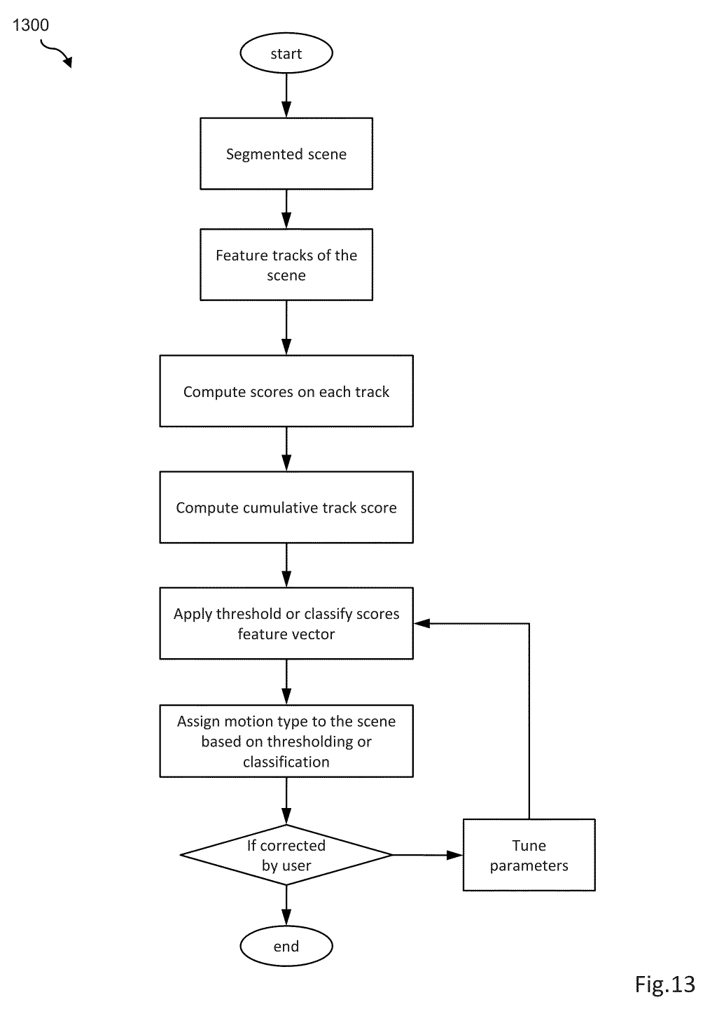

Once scene segmentation is performed, motion inside each frame is analyzed to classify each scene as static or moving, as illustrated in the flowchart 1300 of FIG. 13. In some cases the tracking performed during scene segmentation is again utilized to perform the scene classification. Several scores are computed on each track such as average displacement between consecutive frames, total displacement between track end points, track smoothness, velocity, or acceleration. In some cases, the scores for each track can be combined to create a cumulative scene motion score. In some cases, the tracks can be used to compute the homography between each pair of consecutive frames, resulting in a set of homographies for a particular video segment. The scene motion can then be computed by transforming a number of points between consecutive frames. After every transformation, the displacement in points between consecutive frames can be measured, and then the average displacement for the entire window (that is, the “cumulative scene motion score”) can be computed.

In some cases, a threshold is applied on the cumulative scene motion score to classify each scene as being moving or static. In some cases the user is also asked to correct the classification decision of scene classification. Each time the user makes a correction, the system may automatically tune the parameters for generating the cumulative team motion score in order to maximize the system's performance.

In many cases, only during small portion of the scene is the camera moving. For example, during the start of a scene the may camera zoom in on a particular person and then remains static. Alternatively, the camera may only move when an object of interest moves during the scene. Such scenes are difficult to classify using cumulative scene motion score. In such cases, the scenes may be segmented into smaller intervals which are individually analyzed and classified as static or moving.

As part of the ongoing process, scene classification module may place each scene in a variety of categories in order to match it to similar scenes. The scene classification module can classify each scene as being either indoor or outdoor and further as being a day time scene or a night time scene or a studio lighting scene. The scenes can be further classified as being captured using a handheld or tripod-mounted camera. Further features, such as whether the scene is single- or dual-anchor can also be determined. This classification is done using various low-level and high level features using, for example, color, gradients, and one or more pieces of face detection software. If the identified type of the scene is a known type, then the on-boarding already completed for the known type can be used to automatically on-board the new scene. For example, if the system has already identified a scene associated with a particular talk show (indoor, studio lights, one anchor) and the target scene to classify of a unseen video is also classified to be indoor, studio lights and a one-anchor scenario, then this new target scene of a new unseen video is automatically on-boarded using the knowledge from already known show.

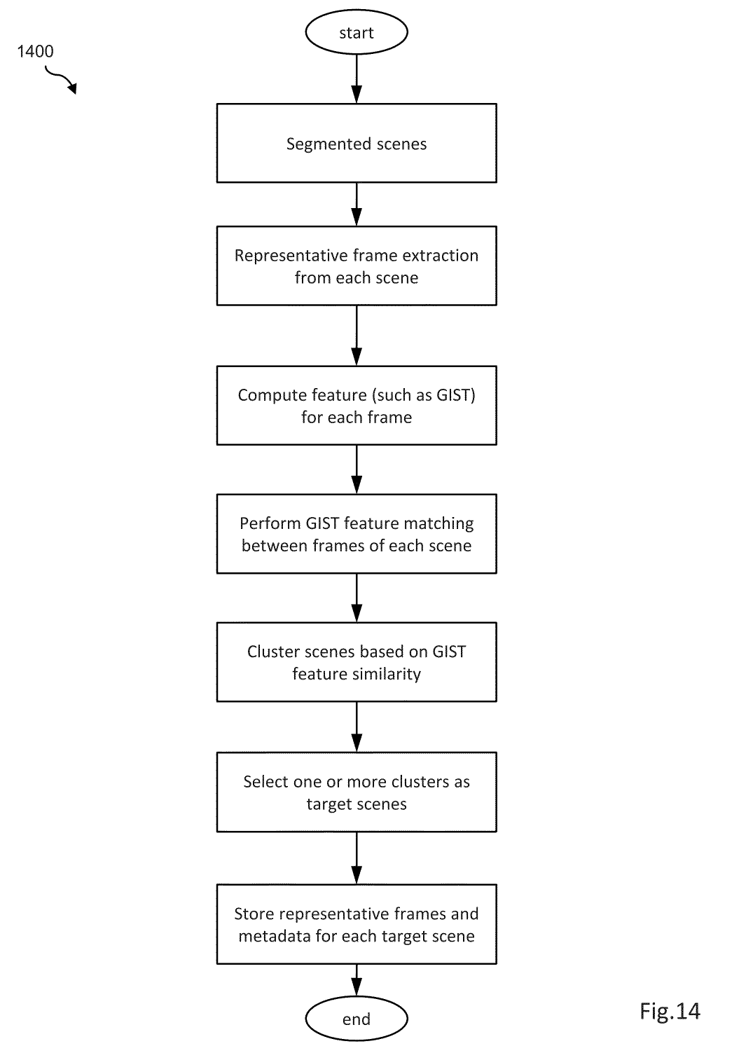

After scene segmentation, the system may undergo a process similar to that described in the flowchart 1400 of FIG. 14. The system may select a small number of frames selected from each scene as representing that scene. In some cases these frames are selected by performing uniform sampling on the frames. In some other cases, the frames are selected such that equal numbers of frame are extracted from each scene irrespective of scene duration. A GIST feature descriptor is then computed on each of the representative image of the scene. These features are then matched among frames of multiple scenes within the video as well as within scenes of multiple videos. GIST similarity between multiple frames of two scenes is combined to obtain a cumulative scene similarity score. If there are, for example, M scenes in a particular video, then this will result in an M×M similarity matrix. In some cases, similar or duplicate scene clusters are created by applying a threshold on the cumulative scene similarity score. In some other cases, a Monte Carlo method such as the Metropolis-Hastings algorithm may be applied to the similarity matrix to find the mutually exclusive duplicate sets. All the unmatched scenes are also grouped together into a single cluster of unassigned scenes.

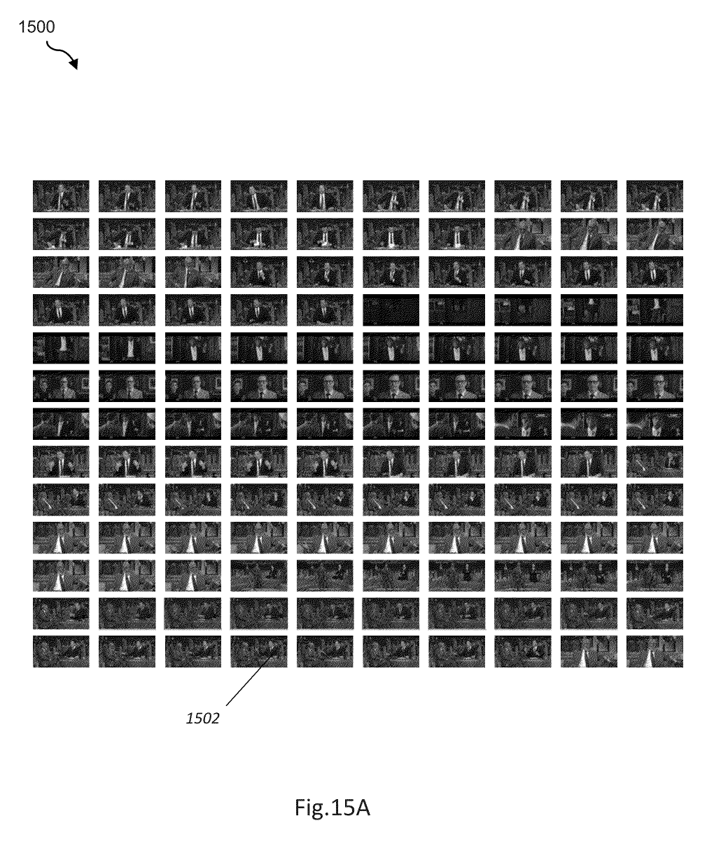

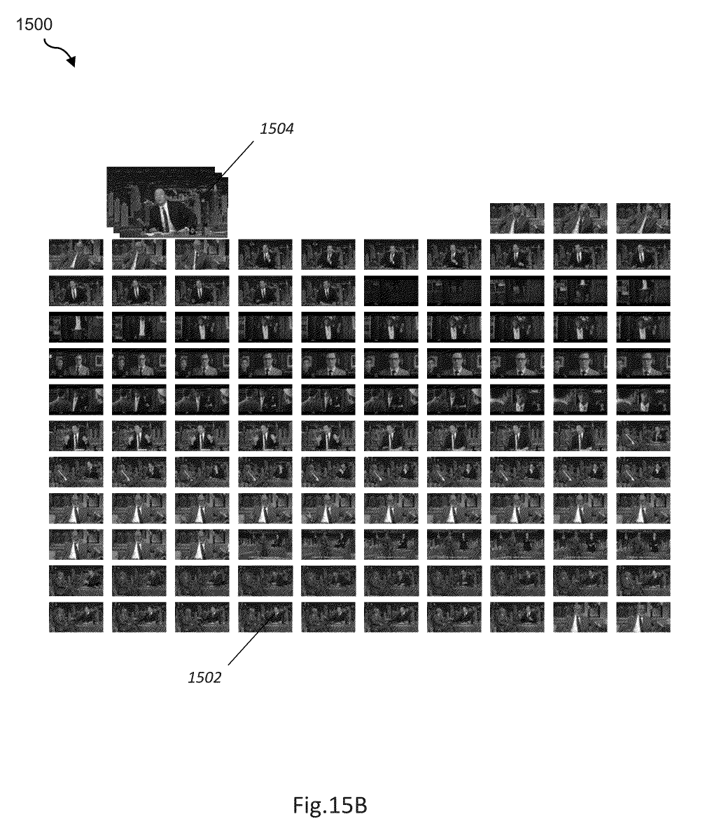

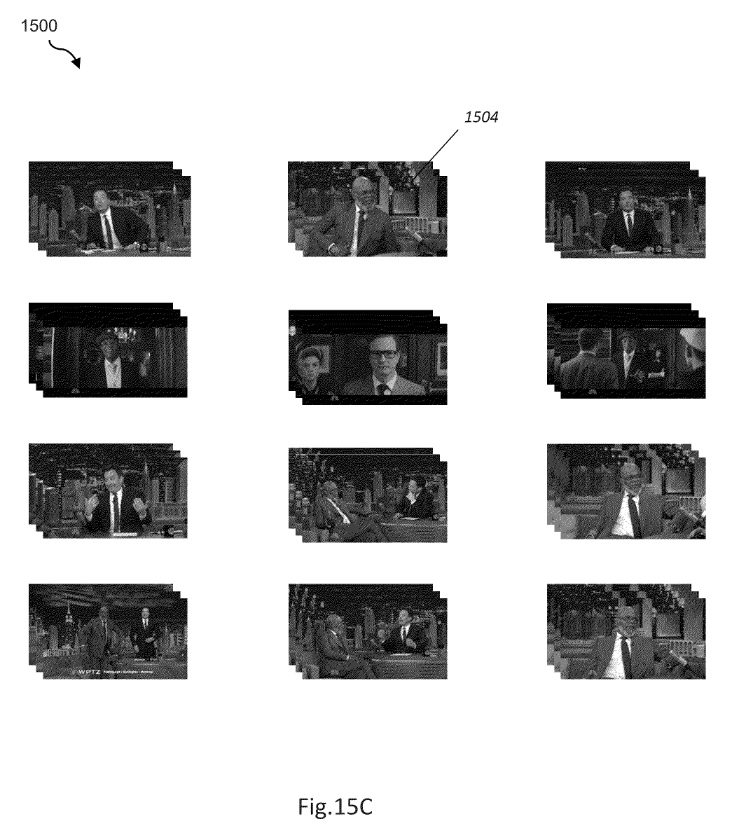

FIGS. 15A-C demonstrate an interface 1500 in which representative frames may be clustered into particular scenes. FIG. 15A shows a sequence of individual frames 1502 which, as shown in FIGS. 15B and 15C, may be gathered automatically or with manual input into clusters 1504.

During on-boarding, the user is presented with a duplicate scene clustering and correction interface to correct any of the incorrect clustering of duplicate scenes. The input provided by the user is then used by an iterative algorithm that tunes the threshold on cumulative scene matching score. Once the scenes are clustered together, some of the clusters are marked as target scenes and are further analyzed for detailed scene understanding.

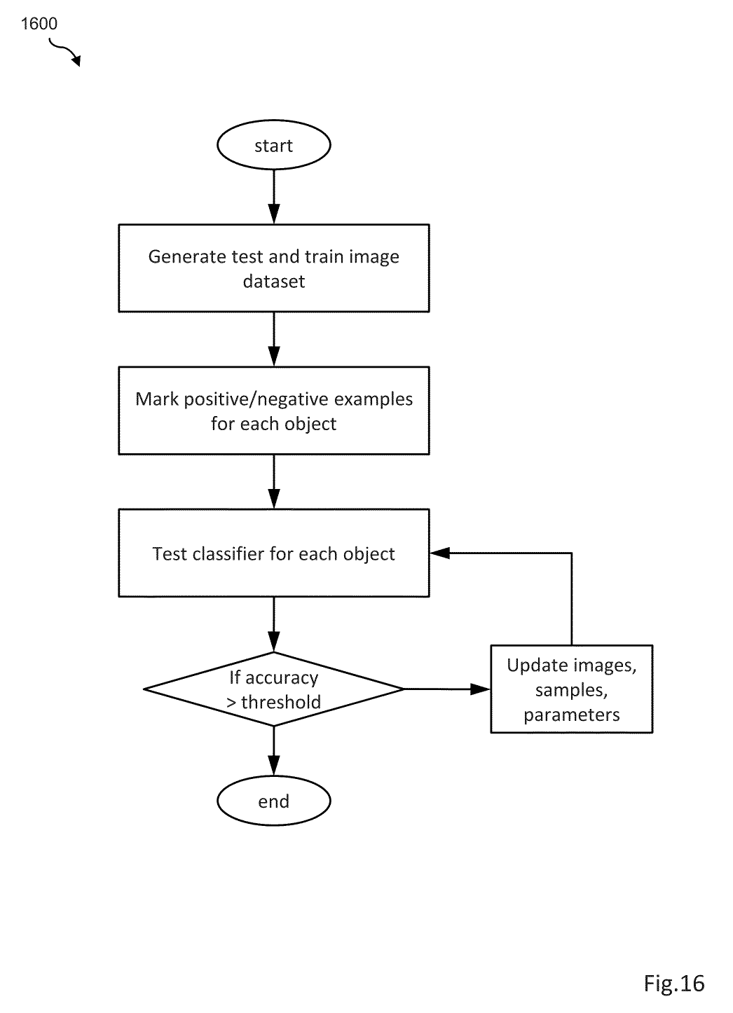

The ingrain system utilizes several already-trained object and environment detectors commonly available as well as object detectors specifically trained by the ingrain system to increase the scene understanding. In some cases, already trained object detectors require retraining by utilizing the examples present in the scenes from the current video set. In some other cases, object detectors and classifiers for additional objects are also trained during the on-boarding process to further improve the scene understanding for the current video and other such videos utilizing the same set. In some cases, the training is performed by cropping out several positive and negative samples from the scene, as described in the flowchart 1600 of FIG. 16. In some cases the training is then performed using Support Vector Machine (SVM) training. In some cases, SVM linear kernels are used; in other cases, non-linear kernels may be employed to further improve the classification. In some cases, deep learning and convoluted neural networks can be used to train object detectors and classifiers.

In some cases, the user can be presented with the interface similar to that described above with respect to FIG. 5 that allows users to mark planes in the scene during on-boarding. These planes are then stored in the metadata files and are transformed on to the duplicate scenes matched in unseen videos from similar or same set.

In some embodiments, scene lighting information is also extracted so that new content can be realistically rendered. This includes identifying directional light 3D vectors for shadow creation, directional light 3D vectors for reflection, parameters of plane (A,B,C,D) on which the creative will be placed, an optional weight value indicating gradient for shadow and reflection, and an optional value indicating alpha for shadow and reflection. In some cases these vectors and plane parameters are extracted automatically by analyzing color information in the scene and utilizing shape from shading and single view reconstruction, such as by exploiting angle regularity as described above. Based on this information, 4-point correspondence between creative and the plane (for spot suggestion) is established and a transformation is computed to create the shadow and reflection layers.

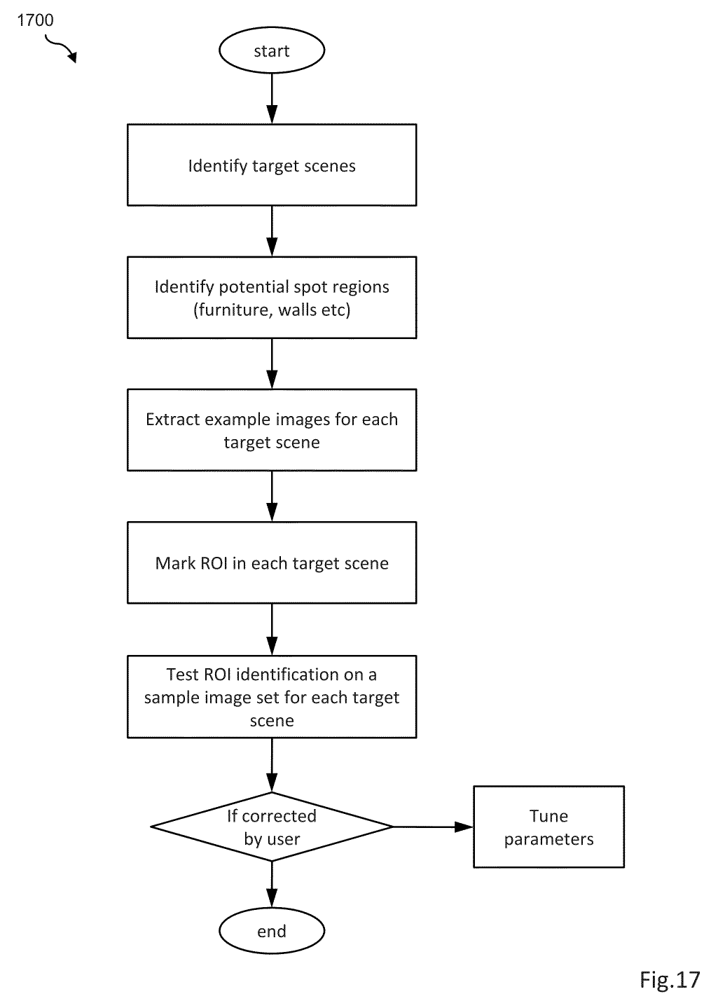

In some implementations, several standard object detectors are applied on the target scene to further enhance the understanding of the scene. For example, different detectors may be use for faces, people, upper bodies, furniture, and common objects. In some cases, the output of these detectors are aggregated together to get better understanding of the scene. For example, localization of face detector, shelves, and objects on shelves can provide information about available empty space on the shelves where a product can be placed. All such locations in the scene are recorded and combined to create a larger region of interest (ROI) where there is a possibility of detecting objects of interest as well as finding spaces for spot insertion. In some cases the user can also create a polygon to define a ROI. FIG. 17 illustrates a flowchart 1700 that includes method steps for marking and testing spot ROI in accordance with some implementations of the present invention.

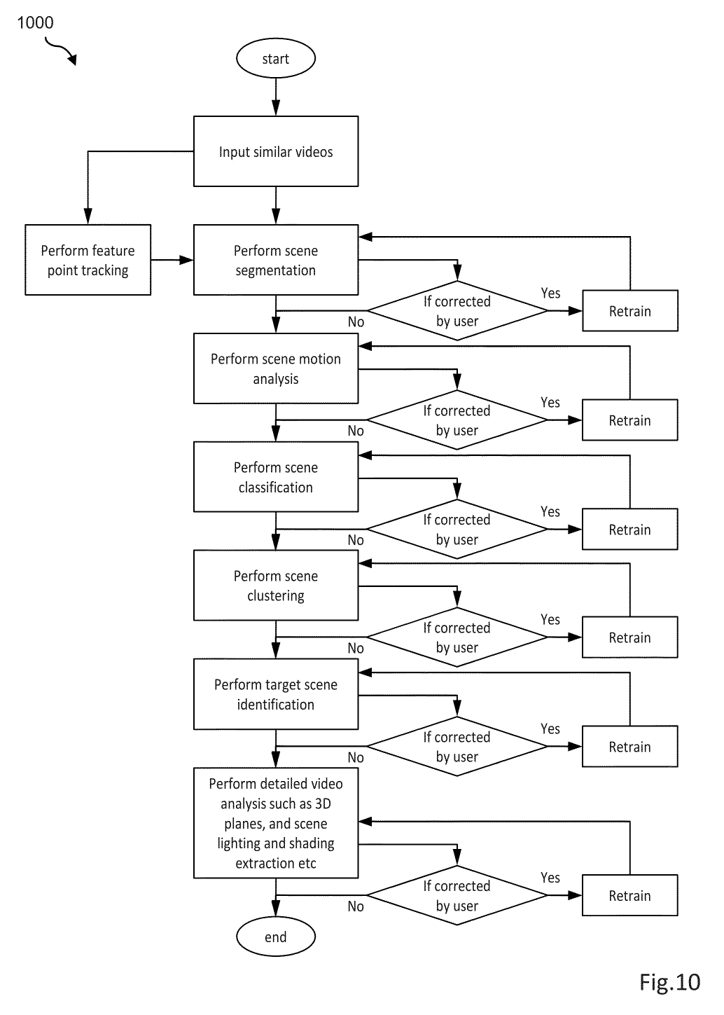

In some cases, on-boarding is performed fully automatically resulting in an automatic generation of configuration files and metadata for the new unseen show/set of videos. In automatic on-boarding, results produced by different modules are directly passed to the next module without user correction/update as shown in FIG. 10. For example, scene segmentation performed using default parameters is directly passed to the next module without requiring any user review and correction. This indicates that default alpha, beta and/or threshold on track continuity already defined in the default configuration file created by the ingrain system is used without modification which leads to the automatic on-boarding aspect of the present invention. Similarly, the automatic scene classification performed using default parameters is directly passed to the next module without requiring any user review and correction. This indicates that the threshold on cumulative scene motion score already defined in the default configuration file created by the ingrain system is used without modification which leads to the automatic on-boarding aspect of the present invention. Same applies to the other modules of the system as shown in FIG. 10.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A method for automatic detection of augmentable regions in videos, comprising:
receiving an unprocessed video comprising one episode of a plurality of related episodes;
identifying a plurality of videos of the plurality of related episodes that have been previously processed to identify one or more augmentable regions;
matching at least one segment of the unprocessed video to at least one segment of the identified plurality of processed videos; and
processing the unprocessed video by identifying one or more augmentable regions based on the matched segments.

2. A method for targeted video augmentation, comprising:
receiving user data associated with a user requesting a video;
retrieving metadata including at least one augmentable region identified in the requesting video;
selecting content from a plurality of content choices based on the user data; and
displaying to the user the requested video augmented with the selected content.

3. The method of claim 2, wherein the selected content is an advertisement selected from a plurality of advertisements.

4. The method of claim 3, wherein the selected content can be clicked by the user during display of the video to trigger the display of additional content to the user associated with the advertisement.

5. The method of claim 2, wherein the content is a product placed so as to appear to be a physical object within a scene represented by the video.
